(19) United States
(12) Patent Application Publication
(10) Pub. No.: US 2014/0050887 A1
(43) Pub. Date: Feb. 20, 2014

(54) RELEASING FILM FOR CERAMIC GREEN SHEET PRODUCTION PROCESSES

(71) Applicants: Tomomi Fukaya, Itabashi-ku (JP); Keiichi Sato, Itabashi-ku (JP)

(72) Inventors: Tomomi Fukaya, Itabashi-ku (JP); Keiichi Sato, Itabashi-ku (JP)

(73) Assignee: LINTEC CORPORATION, Tokyo (JP)

(21) Appl. No.: 14/112,060

(22) PCT Filed: Apr. 9, 2012
(86) PCT No.: PCT/JP2012/059678

§ 371 Date: Nov. 4, 2013

(30) Foreign Application Priority Data
Apr. 21, 2011 (JP) 2011-094755

(51) Int. Cl. B32B 33/00; B32B 3/26

(52) U.S. Cl. CPC B32B 33/00; B32B 3/263
USPC 428/141

(57) ABSTRACT

A releasing film for ceramic green sheet production processes a base material, a resin layer laminated on a first surface of the base material. The resin layer has a conductive polymer and with a thickness of 30-290 nm. A releasing agent layer is laminated on the resin layer, and the surface of the releasing agent layer has a maximum profile peak height of 10-100 nm. A second surface of the base material preferably has an arithmetic mean roughness of 5-50 nm and a maximum profile peak height of 40-300 nm. Such a releasing film can obtain high smoothness of the releasing agent layer and effectively suppress the electrostatic charge while suppressing the releasing agent layer from dropping off.

### TECHNICAL FIELD

The present invention relates to a releasing film to be used in a process for producing a ceramic green sheet.

### BACKGROUND ART

In electronic devices, due to recent demands from the marketplace for downsizing and weight saving, components that constitute electronic devices have been required to be made thin with reduced weight in general. In response to this, the thickness of ceramic green sheets also progresses to further reduced thickness from the current 1 to 5 μm, and ceramic green sheets having a thickness less than 1 μm are produced. Such thin ceramic green sheets cannot accept conventional process films, and may have to require a higher performance process film, i.e., a process film which has excellent ceramic slurry applicability and ceramic green sheet releasability while being prevented from heat contraction wrinkling and which has considerably high smoothness such that the surface does not have any irregularity affecting the sheet thickness.

As a conventional process film, a releasing film is generally used in which an addition reaction-type silicone resin is applied to a polyethylene terephthalate (PET) film as a base material to form a releasing agent layer. However, necessary smoothness of the releasing agent layer has been increased over the years so that a base material having a considerably highly smooth surface is used, and the adhesiveness of the releasing agent layer to the base material is thus reduced because anchor effect of the silicone resin cannot easily be obtained. Accordingly, problems have occurred such as that the releasing agent layer may drop off from the base material due to rolled-up tightening in the core when they are rolled up into a roll-shape.

In this respect, there have conventionally been established an approach such that primer treatment is conducted to the base material in order to enhance the adhesiveness of the releasing agent layer to the base material. Such an approach includes, for example, a method in which a primer layer comprising a metal silicon compound and a silane coupling agent is preliminarily applied to a PET film and an addition reaction-type silicone compound is applied thereto.

However, the highly smooth releasing film applied thereto with a silicone resin involves various problems, such as that rolling-up failure is caused and the electrostatic charge capability increases at the time of rolling-out, because blocking is likely to occur due to demands for higher smoothness. For example, unduly high smoothness of the front and back surfaces may cause adhesion to occur therebetween so that normal rolling-up may be difficult. Defects may otherwise be caused, such as that foreign substances remain attached to the releasing agent layer surface due to electrostatic charge at the time of rolling-out and pinholes occur in the ceramic slurry applied to the releasing agent layer. Moreover, a uniform thin film sheet cannot be formed because fluctuation and crawling may be caused in the applied ceramic slurry due to electrostatic charge of the release agent film surface. In the process for releasing the ceramic green sheet formed on the releasing agent layer from the releasing film, releasing failure due to electrostatic charge in the releasing agent layer may be caused, and a problem may occur that the ceramic green sheet cannot be released in a normal way, such as breakage of the sheet.

In this regard, an approach is conducted in which partial hydrolysate of silicon alkoxide is preliminarily applied to a PET film to provide a silicon oxide layer and the releasing agent layer is provided thereon thus having the adhesiveness to the base material and antistatic property, for example. In the case of being stored for long period of time and/or under high humidity, however, the silicon oxide layer and the base material may deteriorate in the adhesiveness thereby to result in dropping-off of the releasing agent layer.

To achieve antistatic property, a base material is known in which alkyl ammonium salt or the like that has high antistatic property is applied by means of inline coating at the time of film forming of the base material thereby to provide an antistatic layer (Patent Literatures 1, 2).

### PRIOR ART LITERATURE

### Patent Literature

[Patent Literature 1] JP06-172562A
[Patent Literature 2] JP07-68388B

### SUMMARY OF THE INVENTION

### Problems to be Solved by the Invention

However, applying the addition reaction-type silicone to the surface of the above antistatic layer may cause the antistatic layer to be a catalyst poison, leading to problems such as in curability and adhesiveness of the silicone. In a structure such that the releasing agent layer is provided on the surface of the base material opposite to the above antistatic layer, adhesiveness cannot be obtained between the highly smooth base material and the releasing agent layer and the antistatic layer has less film strength and slippery surface, so that dropping-off of the antistatic layer may occur due to contact with guide rolls and the like when the releasing agent is applied and the film is cut. This may cause the dropped-off antistatic layer to be involved as foreign substances into the releasing film when it is rolled up into a roll-shape, thereby to result in a problem of scratches occurring. Such foreign substances involved into the rolled-up releasing film may accumulate on guide rolls and the like in the process for applying ceramic slurry, which may pollute the process thereby to cause ceramic slurry application failure.

The present invention has been made in consideration of such circumstances, and objects of the present invention include providing a releasing film that can obtain high smoothness of the releasing agent layer and effectively suppress the electrostatic charge while suppressing the releasing agent layer from dropping off.

### Means for Solving the Problems

To achieve the above objects, first, the present invention provides a releasing film for ceramic green sheet production processes, comprising: a base material; a resin layer laminated on a first surface of the base material, the resin layer comprising a conductive polymer and having a thickness of 30-290 nm; and a releasing agent layer laminated on the resin layer, wherein a surface of the releasing agent layer has a maximum profile peak height (Rp) of 10-100 nm (Invention 1).

The releasing film according to the above invention (Invention 1) can obtain high smoothness due to the releasing agent layer in which the maximum profile peak height (Rp) is controlled, and effectively suppress the electrostatic charge, such as when being rolled out, due to the presence of the resin layer that contains a conductive polymer. Providing the resin layer between the base material and the releasing agent layer can suppress the releasing agent layer from dropping off even in the case of long term storage. Such a releasing film allows a thin film ceramic green sheet without pinholes to be successfully produced.

In the above invention (Invention 1), it is preferred that a second surface of the base material has an arithmetic mean roughness (Ra) of 5-50 nm and a maximum profile peak height (Rp) of 40-300 nm (Invention 2).

In the above inventions (Inventions 1, 2), it is preferred that the resin layer comprises at least one selected from the group consisting of polyester resin, urethane resin and acrylic resin (Invention 3).

In the above inventions (Inventions 1-3), it is preferred that the resin layer comprises, as the conductive polymer, at least one selected from the group consisting of polythiophene-based conductive polymer, polyaniline-based conductive polymer and polypyrrole-based conductive polymer (Invention 4).

In the above inventions (Inventions 1-4), it is preferred that the releasing agent layer comprises a releasing agent that comprises an addition reaction-type silicone resin as a main component (Invention 5).

In the above inventions (Inventions 1-5), it is preferred that if: a peel force X represents a 180° peel force (mN/20 mm) of a polyester pressure-sensitive adhesive tape No. 31B available from NITTO DENKO CORPORATION with respect to the releasing agent layer; and a peel force Y represents a 180° peel force (mN/20 mm) of a polyester pressure-sensitive adhesive tape No. 31B available from NITTO DENKO CORPORATION with respect to a polished surface that was obtained by polishing the surface of the releasing agent layer using a Japan Society for the Promotion of Science (JSPS)-type fastness-to-rubbing tester with a polishing piece of the second surface of the base material under a condition of a weight of 1 kg and 10 times reciprocating, a releasing agent layer retention rate represented by (peel force X/peel force Y)×100% is 85% or more (Invention 6).

In the above inventions (Inventions 1-6), it is preferred that an electrostatic charge amount at the surface of the releasing agent layer is 10 kV or less immediately after the releasing film rolled up into a roll-shape and having a width of 400 mm and a length of 5,000 m is rolled out with a speed of 100 m/min (Invention 7).

### Advantageous Effect of the Invention

The releasing film according to the present invention can obtain high smoothness of the releasing agent layer and effectively suppress the electrostatic charge, such as when being rolled out, while suppressing the releasing agent layer from dropping off even in the case of long term storage, and thus allows a thin film ceramic green sheet without pinholes to be successfully produced.

### BRIEF DESCRIPTION OF DRAWINGS

FIG. 1 is a cross-sectional view of a releasing film according to one embodiment of the present invention.

### EMBODIMENTS FOR CARRYING OUT THE INVENTION

Embodiments of the present invention will hereinafter be described.

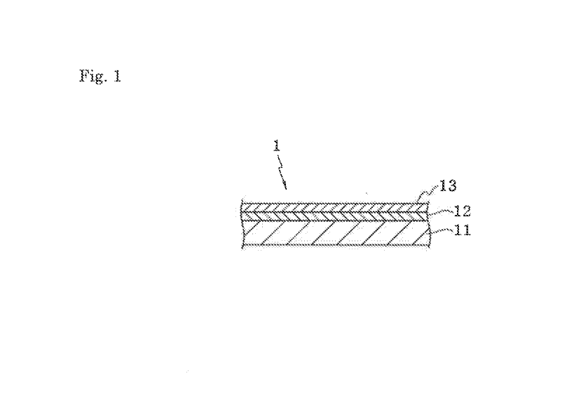

As shown in FIG. 1, releasing film 1 according to the present embodiment comprises: a base material 11; a resin layer 12 laminated on a first surface (upper surface in FIG. 1) of the base material 11 and containing a conductive polymer; and a releasing agent layer 13 laminated on the resin layer 12. The releasing film 1 according to the present embodiment is to be used in a process for producing a ceramic green sheet.

The base material 11 may be, such as, but not limited to, appropriately selected from any of conventionally known ones. Such base material 11 includes, for example, films formed of plastic, such as polyethylene terephthalate, polyethylene naphthalate and other polyester, polypropylene, polymethylpentene and other polyolefin, polycarbonate, and polyvinyl acetate, which may be a single layer, or may be multilayer of two or more layers of the same or different. Among them, polyester film is preferable, polyethylene terephthalate film is particularly preferable, and biaxial stretched polyethylene terephthalate film is further preferable. When being fabricated and used, polyethylene terephthalate film is unlikely to generate dust and the like, and can effectively prevent troubles, such as ceramic slurry application failure, due to dust and the like, for example.

The first surface of the base material 11 may be subjected to surface treatment such as using oxidation method or primer treatment for the purpose of improving the adhesiveness to the resin layer 12 to be provided on the first surface. The above oxidation method includes, for example, corona discharge treatment, plasma discharge treatment, chromium oxidation treatment (wet type), flame treatment, hot-air treatment, ozone exposure treatment, and ultraviolet irradiation treatment. These surface treatment methods may be appropriately selected depending on the type of the base material film, and the corona discharge treatment method may preferably be used in view of the effect and the operability in general.

The thickness of the base material 11 may be ordinarily 10 to 300 μm, preferably 15 to 200 μm, and particularly preferably 20 to 125 μm.

The first surface of the base material 11 may preferably have a maximum profile peak height (Rp) of 10-100 nm, and particularly preferably 20-50 nm. Setting the maximum profile peak height (Rp) at the first surface of the base material 11 within such a range may allow a maximum profile peak height (Rp) at the surface of the releasing agent layer 13 to easily fall within a certain range as will be described later.

The second surface (opposite surface to the first surface; lower surface in FIG. 1) of the base material 11 may preferably have an arithmetic mean roughness (Ra) of 5-50 nm, and particularly preferably 10-30 nm. The second surface of the base material 11 may also preferably have a maximum profile peak height (Rp) of 40-300 nm, and particularly preferably 60-220 nm.

If the arithmetic mean roughness (Ra) of the second surface of the base material 11 is unduly small, then the second surface may be excessively smooth, so that the second surface of the base material 11 and the highly smooth releasing agent layer 13 adhere to each other to cause blocking when the releasing film 1 is rolled up. If the arithmetic mean roughness (Ra) of the second surface of the base material 11 is unduly large, then it may be difficult to cause the maximum profile peak height (Rp) of the second surface of the base material 11 to fall within the above preferable range.

If the maximum profile peak height (Rp) of the second surface of the base material 11 is unduly large, then the thickness of the ceramic green sheet may possibly be partially thin because the irregular profile of the second surface of the base material 11 contacting with the ceramic green sheet may be transferred to the ceramic green sheet when the ceramic green sheet is rolled up after being formed. If the maximum profile peak height (Rp) of the second surface of the base material 11 is unduly small, then the second surface of the base material 11 has less irregularity to be flat, so that air may easily be involved on a surface where the base material 11 contacts with a roll during a process for forming the releasing agent layer 13 etc. This may result in troubles such as that the base material 11 being carried runs along a serpentine course and is misaligned when rolled up into a roll-shape.

As will be described later, if the additive amount of the conductive polymer is large, which may be added as an antistatic agent to the resin layer 12 of the releasing film 1 according to the present embodiment, then problems may occur such as that the adhesiveness of the releasing agent layer 13 deteriorates. In this regard, it is preferred that the additive amount is small, but in which case sufficient antistatic property may not be obtained, and the rolling-out electrostatic charge amount in the releasing film 1, which will be described later, may possibly increase. If the arithmetic mean roughness (Ra) and the maximum profile peak height (Rp) at the second surface of the base material 11 are within the ranges as described above, then blocking is suppressed and electrostatic charge can thus be more effectively suppressed when the releasing film 1 according to the present embodiment is rolled out.

Since the preferable range of the maximum profile peak height (Rp) of the first surface of the base material 11 is different from that of the second surface as described above, the base material 11 may preferably be such that the maximum profile peak height (Rp) of the first surface is different from that of the second surface, i.e., the base material 11 may preferably have different roughness degree between the front surface and the back surface.

As a method for obtaining the base material 11 having different roughness degree between the front surface and the back surface, a method according to co-extrusion film forming may be mentioned, for example, in which a first filler-containing molten resin to form the first surface and a second filler-containing molten resin to form the second surface are converged in a nozzle for forming multilayer so as to be extruded into a sheet-shape, which is cooled and then stretched.

The first filler-containing molten resin contains a first filler. The first filler may preferably be an inorganic filler that withstands the melting temperature of the resin, and such an inorganic filler includes, for example, aluminum oxide particles, calcium carbonate particles, and silicon dioxide. The average particle diameter of the first filler may preferably be 0.01-1 μm, and more preferably 0.05-0.7 μm. One of the first filler may solely be used, or two or more may be used in combination. The content of the first filler in the first filler-containing molten resin may preferably be 0.03-2 mass parts relative to 100 mass parts of the total amount of starting monomer for the resin.

The second filler-containing molten resin contains a second filler. Preferable material for the second filler is the same as those for the first filler. The average particle diameter of the second filler may preferably be 0.05-2 μm, and more preferably 0.1-1 μm. One of the second filler may solely be used, or two or more may be used in combination. The content of the second filler in the second filler-containing molten resin may preferably be 0.1-3 mass parts relative to 100 mass parts of the total amount of starting monomer for the resin.

So long as the action and the advantageous effect according to the present invention are not impaired, the base material 11 may be such that the maximum profile peak height (Rp) of the first surface is substantially the same as that of the second surface, i.e., the base material 11 may have the same roughness degree between the front surface and the back surface. As a method for obtaining the base material 11 having the same roughness degree between the front surface and the back surface, a method may be mentioned in which a filler-containing molten resin to form a single-layer base material is extruded into a sheet-shape, which is cooled and then stretched, thereby the base material 11 comprising a single resin layer is obtained. It is preferred that the material, the particle diameter and the content of the filler contained in the filler-containing molten resin for forming a single-layer base material are the same as those of the above second filler.

The method for obtaining the base material 11 in which the arithmetic mean roughness (Pa) and/or the maximum profile peak height (Rp) of the first surface and the second surface are within the preferable ranges as described above is not limited to a method using extrusion forming. For example, the base material 11 may also be obtained by a method in which an energy-line curable composition that contains filler is cast on each of the both surfaces of a sheet-like material and exposed to irradiation of energy-line to be cured, or a method in which a solvent-based composition that contains filler is cast on each of the both surfaces of a sheet-like material and the solvent is dried and removed for coating.

The resin layer 12 according to the present embodiment may comprise a resin composition that contains a conductive polymer. The resin layer 12 containing the conductive polymer can thereby exhibit antistatic property. The releasing film 1 according to the present embodiment may have such a resin layer 12 thereby to effectively suppress electrostatic charge when being rolled out etc. Even if a releasing agent such as silicone resin-based releasing agent which uses a metal catalyst for polymerization (addition reaction) is used for the releasing agent layer 13, polymerization reaction may not be inhibited, so that sufficient curability of the releasing agent can easily be obtained.

It is preferred that the resin layer 12 contains, as the main component, at least one selected from the group consisting of polyester resin, urethane resin and acrylic resin. Such resin layer 12 exhibits excellent adhesiveness to both the base material 11 and the releasing agent layer 13. More specifically, the above resin layer 12 may swell to some extent due to the organic solvent contained in the releasing agent thereby causing the resin component in the releasing agent and the resin component in the resin layer 12 to be mixed at the interface, and the adhesiveness can thus be enhanced. This adhesiveness allows the releasing agent layer 13 to be prevented from dropping off even in the case of long term storage.

One of the above resin may solely be used, or different two may be used in combination. In particular, when the base material 11 comprises polyester-based material, in view of the adhesiveness to the releasing agent layer 13 and the above swelling ability, it is preferred that the resin layer 12 contains polyester resin and polyurethane resin as the main component that constitutes the resin layer 12. If the polyester resin is solely used, then sufficient adhesiveness to the polyester-based base material 11 can be obtained, but the polyester resin is a relatively brittle resin and may cause cohesive failure when being cut. If the polyurethane resin is solely used, then the adhesiveness to the polyester-based base material 11 may be poor. Containing copolymerized polyester resin and polyurethane resin in the above manner allows those problems to be solved, and the resin layer 12 can be obtained which has excellent adhesiveness to the polyester-based base material 11 and which is unlikely to break even when being cut. The phrase “containing polyester resin and polyurethane resin” as used herein also means solely containing a polymer that includes a polyester structure and a polyurethane structure in one molecule.

The conductive polymer may appropriately be selected from any of conventionally known ones, among which polythiophene-based, polyaniline-based or polypyrrole-based conductive polymer may be preferable.

Polythiophene-based conductive polymer includes, for example, polythiophene, poly(3-alkylthiophene), poly(3-thiophene-β-ethane sulfonic acid), and mixture of polyalkylene dioxythiophene and polystyrene sulfonate. Polyalkylene dioxythiophene includes, for example, polyethylene dioxythiophene, polypropylene dioxythiophene, and poly(ethylene/propylene)dioxythiophene. Polyaniline-based conductive polymer includes, for example, polyaniline, polymethylaniline, and polymethoxyaniline. Polypyrrole-based conductive polymer includes polypyrrole, poly3-methylpyrrole, and poly3-octylpyrrole. Among these conductive polymers, one may solely be used, or two or more may be used in combination. It is preferred that these conductive polymers are used after being dispersed into water to be of a form of aqueous solution.

The content of the conductive polymer in the resin layer 12 may preferably be 0.1-50 mass % in solid content conversion, particularly preferably 0.3-30 mass %, and further preferably 0.3-10 mass %. If the content of the conductive polymer is less than 0.1 mass %, then sufficient 16 antistatic performance may not be obtained. If the content of the conductive polymer exceeds 50 mass %, then the strength of the resin layer 12 may be reduced to readily cause cohesive failure, and the adhesiveness of the releasing agent layer 13 may deteriorate.

The thickness of the resin layer 12 may be 30-290 nm, and preferably 30-250 nm. If the thickness of the resin layer 12 is less than 30 nm, then film forming property to the surface of the base material 11 may be insufficient, so that pinholes are likely to occur due to repelling. If the thickness of the resin layer 12 exceeds 290 nm, then cohesive failure may readily be caused in the resin layer 12, and the adhesiveness of the releasing agent layer 13 may deteriorate.

To form the above resin layer 12, an application agent of resin composition that contains the conductive polymer may be applied to the first surface of the base material 11 and then dried. The application method to be used includes, for example, gravure-coating method, bar-coating method, spray-coating method, spin-coating method, knife-coating method, roll-coating method, and die-coating method. The application agent of resin composition may contain a solvent that can dissolve or disperse each component of the resin composition. Such solvent to be preferably used includes, for example, ether-based solvent, alcohol-based solvent, and mixed solvent of alcohol-based solvent and purified water.

The releasing agent that constitutes the releasing agent layer 13 include, for example, silicone resin-based releasing agent and non-silicone resin-based releasing agents, such as alkyd resin-based, olefin resin-based, acrylic-based, long-chain alkyl group-containing compound-based, and rubber-based.

The silicone resin-based releasing agent may be classified into solvent-type and solvent-free-type. The solvent-type silicone resin is to be diluted by solvent thereby being application liquid, and can thus be widely used for high molecular weight and high viscosity polymers as well as low viscosity low molecular polymers (oligomer). Therefore, the solvent-type silicone resin releasing agent is easy to control the releasability compared with the solvent-free-type, thus being easily designed in accordance with necessary performance (quality). From another aspect, the silicone resin-based releasing agent may also be classified into addition reaction-type, condensation reaction-type, ultraviolet curable-type, electron beam curable-type, and other types. The addition reaction-type silicone resin has high reactivity and high productivity and further has features such as that the change in peel force after production is small and cure contraction may not occur, and may preferably be used as the releasing agent that constitutes the releasing agent layer 13.

The addition reaction-type silicone resin is not particularly restricted, and various types may be used. For example, those commonly used as conventional thermoset addition reaction-type silicone resin releasing agents may be used. Such addition reaction-type silicone resin includes, for example, easily thermosetting ones that have electrophilic groups as functional groups in molecules, such as vinyl groups or other alkenyl groups and hydrosilyl groups, among which polydimethylsiloxane having such functional groups, or polydimethylsiloxane of which a part or whole of the methyl groups is substituted by aromatic functional groups such as phenyl groups, may be used.

If necessary, silica, silicone resin, antistatic agent, dye, pigment or other additives may be added to the silicone resin-based releasing agent.

To cure the coating film of the applied releasing agent, either of heat treatment in an oven of a coating machine or combination of heat treatment and subsequent ultraviolet irradiation may be used, but the latter may be preferable in view of preventing the occurrence of heat contraction wrinkling of the base material film, curability of silicone, and adhesiveness of the releasing agent to the base material film.

In the case of combination use of heat treatment and ultraviolet irradiation for curing the coating film, it is preferred that photo initiator is added to the releasing agent. The photo initiator to be used may be, such as, but not limited to, appropriately selected from any of conventionally used ones for generating radical caused by irradiation of ultraviolet or electron beam etc. Such a photo initiator includes, for example, benzoins, benzophenones, acetophenones, α-hydroxyketones, α-amino ketones, α-diketone, α-diketone dialkyl acetals, anthraquinones, and thioxanthones.

As the alkyd resin-based releasing agent, an alkyd resin that has a crosslinked structure may be used in general. To form an alkyd resin layer that has a crosslinked structure, a method may be used in which a layer comprising a thermoset resin composition that contains alkyd resin and crosslinking agent and may contain curing catalyst as necessary is heated to be cured. The alkyd-based resin may be a modified resin, such as long-chain alkyl modified alkyd resin and silicone modified alkyd resin.

As the olefin resin-based releasing agent, a crystalline olefin-based resin may be used. Polyethylene or crystalline polypropylene-based resin may be preferable as the crystalline olefin-based resin. Polyethylene includes, for example, high-density polyethylene, low-density polyethylene, and linear low-density polyethylene. Crystalline polypropylene-based resin includes, for example, propylene homopolymer that has isotactic structure or syndiotactic structure and propylene-α-olefin copolymer. Among these crystalline olefin-based resins, one may solely be used, or two or more may be used in combination.

As the acrylic-based releasing agent, an acrylic-based resin that has a crosslinked structure may be used in general. The acrylic-based resin may be a modified resin, such as long-chain alkyl modified acrylic resin and silicone modified acrylic resin.

As the long-chain alkyl group-containing compound-based releasing agent, polyvinyl carbamate obtained by causing polyvinyl alcohol-based polymer to react with long-chain alkyl isocyanate having a carbon number of 8-30, or alkyl urea derivative obtained by causing polyethylenimine to react with long-chain alkyl isocyanate having a carbon number of 8-30, may be used, for example.

As the rubber-based releasing agent, natural rubber-based resin, or synthetic rubber-based resin, such as butadiene rubber, isoprene rubber, styrene-butadiene rubber and acrylonitrile-butadiene rubber, may be used.

The thickness of the releasing agent layer 13 is not particularly limited, but may preferably be 0.01-1 μm, and more preferably 0.03-0.5 μm. If the thickness of the releasing agent layer 13 is less than 0.01 μm, then functionality as the releasing agent layer may not sufficiently be exerted depending on material that constitutes the base material 11 and other factors. If the thickness of the releasing agent layer 13 exceeds 1 μm, then blocking with the second surface of the base material may readily occur when the releasing film 1 is rolled up into a roll-shape, thereby to result in problems such as that rolling-up failure is caused and the electrostatic charge capability increases at the time of rolling-out.

The releasing agent layer 13 can be formed by applying the releasing agent solution, which comprises the releasing agent and if necessary curing agent, diluent and other additives, to the first surface of the base material 11, and drying it to be cured. The application method to be used includes, for example, gravure-coating method, bar-coating method, spray-coating method, spin-coating method, knife-coating method, roll-coating method, and die-coating method.

The surface of the releasing agent layer 13 may have a maximum profile peak height (Rp) of 10-100 nm, and preferably 20-50 nm. Setting the maximum profile peak height (Rp) at the surface of the releasing agent layer 13 within such a range may allow the surface of the releasing agent layer 13 to be highly smooth, and even if a thin film ceramic green sheet having a thickness of 1 μm or less is formed on the surface of the releasing agent layer 13, the thin film ceramic green sheet is unlikely to have pinholes or non-uniform thickness portions, thus exhibiting excellent sheet forming ability.

As previously described, the releasing film 1 according to the present embodiment can suppress the releasing agent layer 13 from dropping off because the resin layer 12 is present which has adhesiveness to the base material 11 and the releasing agent layer 13. More specifically, provided that:

a peel force X represents a 180° peel force (mN/20 mm) of a polyester pressure-sensitive adhesive tape No. 31B available from NITTO DENKO CORPORATION with respect to the releasing agent layer 13; and

a peel force Y represents a 180° peel force (mN/20 mm) of a polyester pressure-sensitive adhesive tape No. 31B available from NITTO DENKO CORPORATION with respect to a polished surface that was obtained by polishing the surface of the releasing agent layer 13 using a Japan Society for the Promotion of Science (JSPS)-type fastness-to-rubbing tester with a polishing piece of the second surface of the base material 11 under a condition of a weight of 1 kg and 10 times reciprocating,

a releasing agent layer retention rate represented by (peel force X/peel force Y)×100% may preferably be 85% or more, and particularly preferably 90% or more.

If the releasing agent layer retention rate is within the above range, then the releasing agent layer 13 is unlikely to drop off from the releasing film 1 such as when it is rolled out during the production of a ceramic green sheet, it is cut, and it is carried during the slurry application process. This may avoid the generation of foreign substances due to dropping-off of the releasing agent layer 13 and prevent the occurrence of ceramic slurry application failure, such as scratches caused by those foreign substances. In particular, if the releasing agent layer retention rate is low, problems may fortunately not be caused during the application of slurry so long as the releasing film 1 is stored under normal conditions, but further if the releasing film 1 is stored under adverse conditions with higher temperature and/or humidity, then the releasing agent layer 13 may drop off such as when the releasing film 1 is carried during the slurry application process. The releasing agent layer retention rate within the above range may allow the releasing agent layer 13 to be prevented from being dropped off such as when the releasing film 1 is carried during the slurry application process even if the releasing film 1 is stored under such adverse conditions.

The releasing film 1 according to the present embodiment exerts antistatic property due to the resin layer 12 that contains the conductive polymer. The performance may specifically be such that the electrostatic charge amount at the surface of the releasing agent layer 13 (rolling-out electrostatic charge amount) is preferably 10 kV or less, and particularly preferably 8 kV or less, immediately after the releasing film 1 rolled up into a roll-shape and having a width of 400 mm and a length of 5,000 m is rolled out with a speed of 100 m/min.

If the rolling-out electrostatic charge amount of the releasing agent layer 13 is within the above range, then preferable antistatic property can be obtained. This can prevent defects such as that foreign substances remain attached to the surface of the releasing agent layer 13 due to electrostatic charge at the time of rolling-out and pinholes occur in the film of slurry applied to the releasing agent layer 13. Moreover, a uniform ceramic green sheet can be formed because fluctuation and repelling are prevented from being caused in the applied ceramic slurry due to electrostatic charge. Also in the process for releasing the ceramic green sheet formed on the releasing agent layer 13 from the releasing film 1, releasing failure due to electrostatic charge can be prevented and the ceramic green sheet can be released in a normal way without breakage.

Considering the antistatic property of the releasing film 1, the surface resistivity of the releasing agent layer 13 may be preferably 1×10⁶-1×10¹²Ω/□, and particularly preferably 1×10⁷-1×10¹⁰Ω/□. The surface resistivity being within such a range may make it easy to adjust the rolling-out electrostatic charge amount of the releasing agent layer 13 within the above preferable range. If the surface resistivity is within such a range and the arithmetic mean roughness (Ra) and the maximum profile peak height (Rp) at the second surface of the base material 11 are within the above-described preferable ranges, then it may be more easy to adjust the rolling-out electrostatic charge amount of the releasing agent layer 13 within the above preferable range.

It should be appreciated that the embodiments heretofore explained are described to facilitate understanding of the present invention and are not described to limit the present invention. Therefore, it is intended that the elements disclosed in the above embodiments include all design changes and equivalents to fall within the technical scope of the present invention.

For example, one or more other layers may be interposed between the base material 11 and the resin layer 12 and/or between the resin layer 12 and the releasing agent layer 13.

### EXAMPLES

The present invention will hereinafter be described further specifically with reference to examples etc, but the scope of the present invention is not limited to these examples etc.

### Example 1

### (1) Preparation of Base Material

A reactor was charged with 86 mass parts of terephthalic acid and 70 mass parts of ethylene glycol then transesterification reaction was performed at about 250° C. for 4 hours. Subsequently, 0.03 mass parts of antimony trioxide, 0.01 mass parts of phosphoric acid and 0.3 mass parts of aluminum oxide particles having an average particle diameter of 0.1 μm were added thereto, and heated gradually from 250° C. to 280° C. while the pressure was gradually reduced to 0.5 mmHg. Four hours later, the polymerization reaction was stopped, and polyethylene terephthalate A (filler-containing resin for forming the first surface) having a limiting viscosity of 0.65 dl/g was obtained.

Polyethylene terephthalate B (filler-containing resin for forming the second surface) having a limiting viscosity of 0.63 dl/g was produced like the polyethylene terephthalate A except for using 1 mass part of calcium carbonate particles having an average particle diameter of 0.5 μm as substitute for the aluminum oxide particles having an average particle diameter of 0.1 μm.

The obtained polyethylene terephthalates A and B were dried at 180° C. for 4 hours in inert gas. To obtain a two-layer structure of A layer/B layer, the polyethylene terephthalate A was supplied to a single screw extruder and molten at a temperature of 290° C. while the polyethylene terephthalate B was supplied to another single screw extruder and molten at a temperature of 290° C. After passing through filtration filter, respectively, the molten polyethylene terephthalates A and B were converged in a nozzle for forming two-layer so as to be extruded into a sheet-shape of A layer/B layer, followed by cooling and solidification on a cooling roll set at a surface temperature of 40° C., and an unstretched sheet was thus obtained. The obtained sheet was stretched at 100° C. to 3.5 times in the longitudinal direction and then stretched at 100° C. to 3.5 times in the lateral direction by using a tenter. Thereafter, heat fixation was conducted at 230° C., and a polyester film was obtained as the base material to have a thickness of 38 μm and different roughness degree between the front surface and the back surface. In this base material, the surface of the stretched A layer represents the first surface and the surface of the stretched B layer represents the second surface. The maximum profile peak height (Rp) of the first surface of the obtained base material was 36 nm, while the arithmetic mean roughness (Ra) and the maximum profile peak height (Rp) of the second surface were 12 nm and 84 nm, respectively.

### (2) Formation of Resin Layer

Resin application liquid was obtained by diluting a resin composition (P-973 available from Chukyo Yushi Co., Ltd., solid content: 10 mass %), in which polyethylene dioxythiophene (PEDOT) and polystyrene sulfonate (PSS) as conductive polymers were mixed to have the total content of 0.1-1.0 mass % to a mixed resin emulsion including copolymerized polyester and polyurethane, into a mixed liquid of isopropyl alcohol and purified water (mixing rate of 1:1) to have a solid content of 1.0 mass %. This resin application liquid was uniformly applied to the first surface of the above base material to have a thickness after drying of 50 nm and dried at 120° C. for 1 minute thereby to form a resin layer.

### (3) Formation of Releasing Agent Layer

Application liquid having a solid content of 1.5 mass % was prepared by diluting 100 mass parts of a thermoset addition reaction-type silicone (KS-847H available from Shin-Etsu Chemical Co., Ltd.) into toluene and adding thereto with 2 mass parts of platinum catalyst (CAT-PL-50T available from Shin-Etsu Chemical Co., Ltd). This application liquid was uniformly applied to the surface of the above resin layer to have a thickness after drying of 100 nm and dried at 140° C. for 1 minute thereby to form a releasing agent layer, and the releasing film was thus obtained.

### Example 2

A releasing film was prepared in the same manner as Example 1 except for changing the thickness of the resin layer to 100 nm.

### Example 3

A releasing film was prepared in the same manner as Example 1 except for changing the thickness of the resin layer to 200 nm.

### Example 4

Polyethylene terephthalate C (filler-containing resin for forming a base material comprising a single layer of the resin layer) having a limiting viscosity of 0.64 dl/g was produced in the same manner as the polyethylene terephthalate A in Example 1 except for using 1 mass part of calcium carbonate having an average particle diameter of 0.3 μm as substitute for the aluminum oxide particles having an average particle diameter of 0.1 μm. The obtained polyethylene terephthalate C was dried at 180° C. for 4 hours in inert gas, and supplied to a single screw extruder and molten at a temperature of 290° C. After passing through a filtration filter, the obtained polyethylene terephthalate C was extruded from a nozzle into a sheet-shape and cooled and solidified on a cooling roll set at a surface temperature of 40° C., and an unstretched sheet was thus obtained. The obtained sheet was stretched at 100° C. to 3.5 times in the longitudinal direction and then stretched at 100° C. to 3.5 times in the lateral direction by using a tenter. Thereafter, heat fixation was conducted at 230° C., and a polyester film was obtained as the base material to have a thickness of 38 μm and the same roughness degree between the front surface and the back surface. In this base material, one surface of the base material represents the first surface and the other surface represents the second surface. The maximum profile peak height (Rp) of the first surface of the obtained base material was 44 nm, while the arithmetic mean roughness (Ra) and the maximum profile peak height (Rp) of the second surface were 9 nm and 47 nm, respectively. A releasing film was prepared in the same manner as Example 1 except for using this base material.

### Comparative Example 1

A releasing film was prepared in the same manner as Example 1 except for changing the thickness of the resin layer to 20 nm.

### Comparative Example 2

A releasing film was prepared in the same manner as Example 1 except for changing the thickness of the resin layer to 300 nm.

### Comparative Example 3

A releasing film was prepared in the same manner as Example 1 except for not forming the resin layer.

### Comparative Example 4

Polyethylene terephthalate D having a limiting viscosity of 0.62 dl/g was produced in the same manner as the polyethylene terephthalate A in Example 1 except for using 1 mass part of silicon dioxide having an average particle diameter of 1.5 μm as substitute for the aluminum oxide particles having an average particle diameter of 0.1 μm. A polyester film was obtained as the base material to have a thickness of 38 μm and the same roughness degree between the front surface and the back surface in the same manner as Example 4 except for using this polyethylene terephthalate D as substitute for the polyethylene terephthalate C. The maximum profile peak height (Rp) of the first surface of the obtained base material was 527 nm, while the arithmetic mean roughness (Ra) and the maximum profile peak height (Rp) of the second surface were 36 nm and 532 nm, respectively. A releasing film was prepared in the same manner as Example 1 except for using this base material.

### Comparative Example 5

A releasing film was prepared in the same manner as Example 1 except for using the polyester film obtained in Comparative Example 4 as the base material and not forming the resin layer.

### Comparative Example 6

The polyester film obtained in Example 1 was used as the base material. Partial hydrolysate of tetraethoxysilane (COLCOAT N-103X available from COLCOAT CO., LTD.) was diluted by isopropyl alcohol to be an application liquid having a solid content of 1.5 mass %, and the application liquid was uniformly applied to the first surface of the polyester film to have a thickness after drying of 100 nm and dried at 120° C. for 1 minute thereby forming an antistatic layer. A releasing agent layer was formed on the antistatic layer in the same manner as Example 1, and a release film was thus obtained.

### Comparative Example 7

The base material was prepared by using a PET film provided with an antistatic layer (thickness: 20 nm) comprising alkyl ammonium salt on the first surface (Diafoil T100G available from Mitsubishi Plastics, Inc.). In this PET film, the maximum profile peak height (Rp) of the surface of the antistatic layer was 502 nm while the arithmetic mean roughness (Ra) and the maximum profile peak height (Rp) of the second surface were 36 nm and 522 nm, respectively, and the thickness (including that of the antistatic layer) was 38 μm. A releasing agent layer was formed on the antistatic layer in the same manner as Example 1, and a release film was thus obtained.

### Exemplary Test 1

### Surface Roughness Measurement

A surface roughness measurement device (Surftest SV-3000S4 available from Mitutoyo Corporation) was used to measure, in conformity with JIS B0601: 2001, the arithmetic mean roughness (Ra) and/or the maximum profile peak height (Rp) of the first surface and the second surface of each base material used in the examples and the comparative examples and the surface of the releasing agent layer of each releasing film obtained in the examples and the comparative examples. The results are listed in Table 1.

### Exemplary Test 2

### Surface Resistivity Measurement

Releasing films obtained in the examples and the comparative examples were each cut into a sample of 100 mm×100 mm. After being exposed to humidity controlled condition under a temperature of 23° C. and a humidity of 50% for 24 hours, the sample was subjected to measurement of resistivity at the surface of the releasing agent layer side using “R12704 Resistivity Chamber” and “Digital Electrometer R8285” both available from ADVANTEST CORPORATION in conformity with JIS K6911 (1995). The results are listed in Table 2.

### Exemplary Test 3

### Releasing Agent Layer Retention Rate Measurement

Releasing films obtained in the examples and the comparative examples were stored under a condition of a temperature of 60° C. and a humidity of 90% for 72 hours. Thereafter, a part of the surface of the releasing agent layer of each releasing film was polished using a Japan Society for the Promotion of Science (JSPS)-type fastness-to-rubbing tester with a polishing piece of the second surface of the same base material (polyester film) as each of those used in releasing films obtained in the examples and the comparative examples under a condition of a weight of 1 kg and 10 times reciprocating. Subsequently, a polyester pressure-sensitive adhesive tape (No. 31B available from NITTO DENKO CORPORATION, thickness: 50 μm, width: 20 mm) was applied to each of the polished part and the unpolished part of the releasing agent layer using a roller of 2 kg reciprocating one time, and this was used as a sample.

The obtained sample was cured under a condition of a temperature of 23° C. and a humidity of 50% for 24 hours thereafter being cut into a width of 40 mm and a length of 150 mm, and each polyester pressure-sensitive adhesive tape side was peeled off at a peel angle of 180° and with a peel speed of 300 m/min to measure the peel force. The releasing agent layer retention rate (%) was calculated using the equation below:

Releasing Agent Layer Retention Rate=(peel force X/peel force Y)×100%

where peel force X represents the peel force at the unpolished part and peel force Y represents the peel force at the polished part. The results are listed in Table 2.

### Exemplary Test 4

### Blocking Resistance Evaluation

Each releasing film obtained in the examples and the comparative examples was rolled up into a roll-shape with a width of 400 mm and a length of 5,000 m. This releasing film roll was stored under an environment of a temperature of 40° C. and a humidity of 50% for 30 days, and the appearance thereof was visually observed. Those observed without any change from when rolled up into a roll-shape were evaluated as absence of blocking (∘), those observed with different color within half or less region were evaluated as presence of little blocking (Δ), and those observed with different color within over half region were evaluated as presence of blocking (x). The results are listed in Table 2.

### Exemplary Test 5

### Rolling-Out Electrostatic Charge Amount Measurement

Each releasing film obtained in the examples and the comparative examples was rolled up into a roll-shape with a width of 400 mm and a length of 5,000 m. This releasing film roll was rolled out with a speed of 100 m/min using a cutting machine, and the electrostatic charge amount at the releasing agent layer surface immediately after rolling-out (rolling-out electrostatic charge amount) was measured using “Explosion-proof type digital static meter KSD-0108” available from KASUGA DENKI, Inc. Measured values less than 8 kV were indicated by “A”, 8 kV or more and less than 12 kV by “B”, and 12 kV or more by “C”. The results are listed in Table 2.

### Exemplary Test 6

### Slurry Applicability Evaluation

Ceramic slurry was prepared by adding 135 mass parts of mixed liquid of toluene and ethanol (mass ratio of 6:4) to 100 mass parts of barium titanate powder (BaTiO₃; BT-03 available from Sakai Chemical Industry Co., Ltd.), 8 mass parts of polyvinyl butyral (S-LEC B K BM-2 available from SEKISUI CHEMICAL CO., LTD.) as binder, and 4 mass parts of dioctyl phthalate (dioctyl phthalate Cica first grade available from KANTO CHEMICAL CO., INC.) as plasticizer, and mixing and dispersing them using a ball mill.

The above ceramic slurry was applied using a die coater to the releasing agent layer surface of each releasing film obtained in the examples and the comparative examples to have a width of 250 mm and a length of 10 m so that the film thickness after drying would be 1 μm, and thereafter dried at 80° C. for 1 minute using a drier. The releasing film formed thereon with the ceramic green sheet was irradiated by fluorescent tube light from the releasing film side, and the ceramic green sheet surface was visually checked. Those observed without pinholes in the ceramic green sheet were indicated by “A”, those observed with one to five pinholes occurring by “B”, and those observed with six or more pinholes occurring by “C”. The results are listed in Table 2.

TABLE 1

| | Resin | Releasing | Surface roughness (nm) | | | |
|---|---|---|---|---|---|---|
| | layer | agent layer | Releasing agent | | Base material | |
| | thickness | thickness | layer surface | | second surface | |
| | (nm) | (nm) | Ra | Rp | Ra | Rp |
| Example 1 | 50 | 100 | 5 | 36 | 12 | 84 |
| Example 2 | 100 | 100 | 5 | 36 | 12 | 84 |
| Example 3 | 200 | 100 | 6 | 38 | 12 | 84 |
| Example 4 | 50 | 100 | 8 | 44 | 9 | 47 |
| Comparative | 20 | 100 | 5 | 38 | 12 | 84 |
| Example 1 | | | | | | |
| Comparative | 300 | 100 | 6 | 39 | 12 | 84 |
| Example 2 | | | | | | |
| Comparative | — | 100 | 5 | 38 | 12 | 84 |
| Example 3 | | | | | | |
| Comparative | 50 | 100 | 35 | 527 | 36 | 532 |
| Example 4 | | | | | | |
| Comparative | — | 100 | 35 | 511 | 36 | 532 |
| Example 5 | | | | | | |
| Comparative | 100* | 100 | 6 | 35 | 12 | 84 |
| Example 6 | | | | | | |
| Comparative | 20* | 100 | 35 | 502 | 36 | 522 |
| Example 7 | | | | | | |

*In Comparative Examples 6 and 7, thickness of antistatic layer

TABLE 2

| | | Releasing | | | |
|---|---|---|---|---|---|
| | | agent | | | |
| | | layer | Rolling-out | | |
| | Surface | retention | electrostatic | | Slurry |
| | resistivity | rate | charge | Blocking | applica- |
| | (Ω/□) | (%) | amount (kV) | resistance | bility |
| Example 1 | 10⁹ | 95 | A(7) | ∘ | A |
| Example 2 | 10⁹ | 91 | A(6) | ∘ | A |
| Example 3 | 10⁸ | 92 | A(4) | ∘ | A |
| Example 4 | 10⁹ | 93 | B(11) | Δ | A |
| Comparative | 10¹⁰ | 40 | B(9) | ∘ | A |
| Example 1 | | | | | |
| Comparative | 10⁸ | 35 | A(4) | ∘ | A |
| Example 2 | | | | | |
| Comparative | 10¹⁵ | 23 | C(16) | ∘ | A |
| Example 3 | | | | | |
| Comparative | 10⁹ | 96 | A(6) | ∘ | C |
| Example 4 | | | | | |
| Comparative | 10¹⁵ | 26 | B(9) | ∘ | C |
| Example 5 | | | | | |
| Comparative | 10⁹ | 10 | A(7) | ∘ | A |
| Example 6 | | | | | |
| Comparative | 10⁹ | 22 | A(7) | ∘ | C |
| Example 7 | | | | | |

As apparent from Table 1 and Table 2, releasing films obtained in the examples have preferable surface resistivity and low rolling-out electrostatic charge amount. Moreover, the releasing agent layer retention rate is high, no blocking occurs, and no pinhole occurs in the formed ceramic green sheets.

### INDUSTRIAL APPLICABILITY

The releasing film according to the present invention may preferably be used to form a thin film ceramic green sheet that has a thickness of 1 μm or less.

### EXPLANATION OF NUMERAL REFERENCES

1 . . . Releasing film
11 . . . Base material
12 . . . Resin layer
13 . . . Releasing agent layer

1. A releasing film for ceramic green sheet production processes, comprising:
a base material;
a resin layer laminated on a first surface of the base material, the resin layer comprising a conductive polymer and having a thickness of 30-290 nm; and
a releasing agent layer laminated on the resin layer, wherein
a surface of the releasing agent layer has a maximum profile peak height (Rp) of 10-100 nm.

2. The releasing film as recited in claim 1, wherein a second surface of the base material has an arithmetic mean roughness (Ra) of 5-50 nm and a maximum profile peak height (Rp) of 40-300 nm.

3. The releasing film as recited in claim 1, wherein the resin layer comprises at least one selected from the group consisting of polyester resin, urethane resin and acrylic resin.

4. The releasing film as recited in claim 1, wherein the resin layer comprises, as the conductive polymer, at least one selected from the group consisting of polythiophene-based conductive polymer, polyaniline-based conductive polymer and polypyrrole-based conductive polymer.

5. The releasing film as recited in either claim 1, wherein the releasing agent layer comprises a releasing agent that comprises an addition reaction-type silicone resin as a main component.

6. The releasing film as recited in claim 1, wherein, provided that:
a peel force X represents a 180° peel force (mN/20 mm) of a polyester pressure-sensitive adhesive tape No. 31B available from NITTO DENKO CORPORATION with respect to the releasing agent layer;
a peel force Y represents a 180° peel force (mN/20 mm) of a polyester pressure-sensitive adhesive tape No. 31B available from NITTO DENKO CORPORATION with respect to a polished surface that was obtained by polishing the surface of the releasing agent layer using a Japan Society for the Promotion of Science (JSPS)-type fastness-to-rubbing tester with a polishing piece of the second surface of the base material under a condition of a weight of 1 kg and 10 times reciprocating, and
a releasing agent layer retention rate represented by (peel force X/peel force Y)×100% is 85% or more.

7. The releasing film as recited in claim 1, wherein an electrostatic charge amount at the surface of the releasing agent layer is 10 kV or less immediately after the releasing film rolled up into a roll-shape and having a width of 400 mm and a length of 5,000 m is rolled out with a speed of 100 m/min.

8. The releasing film as recited in claim 2, wherein the resin layer comprises at least one selected from the group consisting of polyester resin, urethane resin and acrylic resin.

9. The releasing film as recited in claim 2, wherein the resin layer comprises, as the conductive polymer, at least one selected from the group consisting of polythiophene-based conductive polymer, polyaniline-based conductive polymer and polypyrrole-based conductive polymer.

10. The releasing film as recited in claim 3, wherein the resin layer comprises, as the conductive polymer, at least one selected from the group consisting of polythiophene-based conductive polymer, polyaniline-based conductive polymer and polypyrrole-based conductive polymer.

11. The releasing film as recited in claim 2, wherein the releasing agent layer comprises a releasing agent that comprises an addition reaction-type silicone resin as a main component.

12. The releasing film as recited in claim 3, wherein the releasing agent layer comprises a releasing agent that comprises an addition reaction-type silicone resin as a main component.

13. The releasing film as recited in claim 4, wherein the releasing agent layer comprises a releasing agent that comprises an addition reaction-type silicone resin as a main component.

14. The releasing film as recited in claim 2, wherein, provided that:
a peel force X represents a 180° peel force (mN/20 mm) of a polyester pressure-sensitive adhesive tape No. 31B available from NITTO DENKO CORPORATION with respect to the releasing agent layer;
a peel force Y represents a 180° peel force (mN/20 mm) of a polyester pressure-sensitive adhesive tape No. 31B available from NITTO DENKO CORPORATION with respect to a polished surface that was obtained by polishing the surface of the releasing agent layer using a Japan Society for the Promotion of Science (JSPS)-type fastness-to-rubbing tester with a polishing piece of the second surface of the base material under a condition of a weight of 1 kg and 10 times reciprocating, and
a releasing agent layer retention rate represented by (peel force X/peel force Y)×100% is 85% or more.

15. The releasing film as recited in claim 3, wherein, provided that:
a peel force X represents a 180° peel force (mN/20 mm) of a polyester pressure-sensitive adhesive tape No. 31B available from NITTO DENKO CORPORATION with respect to the releasing agent layer;
a peel force Y represents a 180° peel force (mN/20 mm) of a polyester pressure-sensitive adhesive tape No. 31B available from NITTO DENKO CORPORATION with respect to a polished surface that was obtained by polishing the surface of the releasing agent layer using a Japan Society for the Promotion of Science (JSPS)-type fastness-to-rubbing tester with a polishing piece of the second surface of the base material under a condition of a weight of 1 kg and 10 times reciprocating, and
a releasing agent layer retention rate represented by (peel force X/peel force Y)×100% is 85% or more.

16. The releasing film as recited in claim 4, wherein, provided that:
a peel force X represents a 180° peel force (mN/20 mm) of a polyester pressure-sensitive adhesive tape No. 31B available from NITTO DENKO CORPORATION with respect to the releasing agent layer;
a peel force Y represents a 180° peel force (mN/20 mm) of a polyester pressure-sensitive adhesive tape No. 31B available from NITTO DENKO CORPORATION with respect to a polished surface that was obtained by polishing the surface of the releasing agent layer using a Japan Society for the Promotion of Science (JSPS)-type fastness-to-rubbing tester with a polishing piece of the second surface of the base material under a condition of a weight of 1 kg and 10 times reciprocating, and
a releasing agent layer retention rate represented by (peel force X/peel force Y)×100% is 85% or more.

17. The releasing film as recited in claim 5, wherein, provided that:
a peel force X represents a 180° peel force (mN/20 mm) of a polyester pressure-sensitive adhesive tape No. 31B available from NITTO DENKO CORPORATION with respect to the releasing agent layer;
a peel force Y represents a 180° peel force (mN/20 mm) of a polyester pressure-sensitive adhesive tape No. 31B available from NITTO DENKO CORPORATION with respect to a polished surface that was obtained by polishing the surface of the releasing agent layer using a Japan Society for the Promotion of Science (JSPS)-type fastness-to-rubbing tester with a polishing piece of the second surface of the base material under a condition of a weight of 1 kg and 10 times reciprocating, and
a releasing agent layer retention rate represented by (peel force X/peel force Y)×100% is 85% or more.

18. The releasing film as recited in claim 2, wherein an electrostatic charge amount at the surface of the releasing agent layer is 10 kV or less immediately after the releasing film rolled up into a roll-shape and having a width of 400 mm and a length of 5,000 m is rolled out with a speed of 100 m/min.

19. The releasing film as recited in claim 3, wherein an electrostatic charge amount at the surface of the releasing agent layer is 10 kV or less immediately after the releasing film rolled up into a roll-shape and having a width of 400 mm and a length of 5,000 m is rolled out with a speed of 100 m/min.

20. The releasing film as recited in claim 4, wherein an electrostatic charge amount at the surface of the releasing agent layer is 10 kV or less immediately after the releasing film rolled up into a roll-shape and having a width of 400 mm and a length of 5,000 m is rolled out with a speed of 100 m/min.
